(19) United States
(12) Patent Application Publication
(10) Pub. No.: US 2025/0093457 A1
(43) Pub. Date: Mar. 20, 2025

(54) POSITIONING SYSTEM AND NON-TRANSITORY STORAGE MEDIUM

(71) Applicant: TOYOTA JIDOSHA KABUSHIKI KAISHA, Toyota-shi (JP)

(72) Inventors: Go HAYASHI, Toyota-shi (JP); Takayoshi YAMAZAKI, Miyoshi-shi (JP); Makoto ISHII, Kunitachi-shi (JP)

(73) Assignee: TOYOTA JIDOSHA KABUSHIKI KAISHA, Toyota-shi (JP)

(21) Appl. No.: 18/882,244

(22) Filed: Sep. 11, 2024

(30) Foreign Application Priority Data
Sep. 15, 2023 (JP) 2023-150010

(51) Int. Cl. G01S 5/02; G01S 5/00

(52) U.S. Cl. CPC G01S 5/0284; G01S 5/017

(57) ABSTRACT

A first computing device calculates a current attitude of a first oscillating body at a first position from a first vector from the first position to a second position and a second vector from the first position to a third position. The first computing device modifies a first reference vector from the first positioning antenna to a first predetermined point in the attitude of the first oscillating body, according to the current attitude. The first computing device calculates the position of the first predetermined point in the current attitude of the first oscillating body by adding the modified first predetermined point vector to the first position. The first computing device acquires the position of the second predetermined point in the current attitude of the second oscillating body calculated from three positions. Then, the first computing device calculates the current positional relationship between the first and second predetermined points.

### CROSS REFERENCE TO THE RELATED APPLICATION

This application claims the benefit of Japanese Patent Application No. 2023-150010, filed on Sep. 15, 2023, which is hereby incorporated by reference herein in its entirety.

### BACKGROUND

### Technical Field

The present disclosure relates to a positioning system and a non-transitory storage medium.

### Description of the Related Art

Japanese Patent Laid-Open No. 2005-207831 discloses a posture detection device that detects a change in posture of a two-wheeled vehicle based on a GPS signal. The attitude detection device disclosed in Japanese Patent Laid-Open No. 2005-207831 includes a first GPS receiver provided at a first position on the vehicle and a second GPS receiver provided at a second position lower than the first position. The attitude detection device also determines first position information based on a GPS signal detected by the first GPS receiver, and determines second position information based on a GPS signal detected by the second GPS receiver. The attitude detection device detects the traveling direction of the vehicle, and detects a change in the attitude of the vehicle based on the first and second position information and the traveling direction of the vehicle.

Japanese Patent Laid-Open No. 2008-298443 discloses a multipath detection device that detects whether multipath waves are included in each carrier wave transmitted from each GPS satellite and received by each GPS antenna in a mobile body in which multiple GPS antennas are installed with the relative positions between the GPS antennas fixed. The multipath detection device disclosed in Japanese Patent Laid-Open No. 2008-298443 inputs carrier phase information indicating the distance between each GPS satellite and each GPS antenna in terms of the number of carrier waves, and uses a CPU to calculate the difference in carrier phase between the same GPS satellite and the GPS antennas based on the input carrier phase information.

The multipath detection device inputs the calculated carrier phase difference between the GPS antennas and a Line Of Sight (LOS) vector indicating the direction from a specific GPS antenna to a specific GPS satellite specified by an arbitrary method, and uses a CPU to calculate a baseline length indicating the distance between the GPS antennas as an observation baseline length based on the input carrier phase difference and the input LOS vector. The multipath detection device uses a CPU to compare a known baseline length, which indicates a pre-calculated distance between GPS antennas, with the observed baseline length, and if the observed baseline length differs from the known baseline length by more than a predetermined threshold value, determines that multipath waves are included in each carrier wave used to calculate the observed baseline length.

### SUMMARY

An object of the present disclosure is to accurately grasp the positional relationship between two oscillating bodies.

A positioning system, according to a first aspect of the present disclosure, includes a first positioning antenna, a second positioning antenna, and a third positioning antenna attached to a first oscillating body, and a first computing device,
the first computing device configured to execute;
   acquiring a first position measured by the first positioning antenna, a second position measured by the second positioning antenna, and a third position measured by the third positioning antenna,
   calculating a current attitude of the first oscillating body at the first position from a first vector from the first position to the second position and a second vector from the first position to the third position,
   modifying a first reference vector from the first positioning antenna to a first predetermined point in the attitude of the first oscillating body at a predetermined time according to the calculated current attitude of the first oscillating body at the first position,
   calculating a position of the first predetermined point in the current attitude of the first oscillating body by adding the modified first reference vector to the first position,
   acquiring a second predetermined point of a second oscillating body to which a fourth positioning antenna, a fifth positioning antenna, and a sixth positioning antenna are attached, the second predetermined point being calculated based on a fourth position measured by the fourth positioning antenna, a fifth position measured by the fifth positioning antenna, and a sixth position measured by the sixth positioning antenna in a current attitude of the second oscillating body, and
   calculating a current positional relationship between the first predetermined point and the second predetermined point by referring to a position of the first predetermined point and a position of the second predetermined point.

A non-transitory storage medium, according to a first aspect of the present disclosure, stores a positioning program for causing a computing device connected to a first positioning antenna, a second positioning antenna, and a third positioning antenna attached to a first oscillating body to execute an information processing method, wherein
the information processing method includes;
   acquiring a first position measured by the first positioning antenna, a second position measured by the second positioning antenna, and a third position measured by the third positioning antenna,
   calculating a current attitude of the first oscillating body at the first position from a first vector from the first position to the second position and a second vector from the first position to the third position,
   modifying a first reference vector from the first positioning antenna to a first predetermined point in the attitude of the first oscillating body at a predetermined time according to the calculated current attitude of the first oscillating body at the first position,
   calculating a position of the first predetermined point in the current attitude of the first oscillating body by adding the modified first reference vector to the first position,
   acquiring a second predetermined point of a second oscillating body to which a fourth positioning antenna, a fifth positioning antenna, and a sixth positioning antenna are attached, the second predetermined point being calculated based on a fourth position measured by the fourth positioning antenna, a fifth position measured by the fifth positioning antenna, and a sixth position measured by the sixth positioning antenna in a current attitude of the second oscillating body, and
   calculating a current positional relationship between the first predetermined point and the second predetermined point by referring to a position of the first predetermined point and a position of the second predetermined point.

According to the present disclosure, it is possible to accurately grasp the positional relationship between two oscillating bodies.

### BRIEF DESCRIPTION OF THE DRAWINGS

FIG. 1 is a diagram showing a schematic configuration of a positioning system;

FIG. 2 is a diagram showing an example of changes in the positions of the antennas and the predetermined point when the first ship and the second ship are oscillating;

FIG. 3 is a diagram showing the positional relationship between a first predetermined point of a first ship and a second predetermined point of a second ship;

FIG. 4 is a block diagram illustrating an example of a functional configuration of a first computing device and a second computing device that configure the positioning system.

FIG. 5 is a flowchart of information processing executed by the controller in the first computing device.

### DESCRIPTION OF THE EMBODIMENTS

Let us consider a case where the positional relationship between two oscillating bodies is to be calculated. At this time, even if the oscillating body is not moving, it is assumed that the position of the predetermined point on the oscillating body will change due to the oscillation of the oscillating body. In other words, it is assumed that the predetermined position on the oscillating body changes depending on the attitude of the oscillating body. In this case, it is expected that the positional relationship between the predetermined point of one oscillating body and the predetermined point of the other oscillating body will change as the attitude of at least one of the two oscillating bodies changes due to oscillation. Therefore, it is difficult to grasp the positional relationship between two predetermined points on the two oscillating bodies. Therefore, the positioning system according to the first aspect of the present disclosure solves such a problem.

A positioning system according to a first aspect of the present disclosure is a system including a first positioning antenna, a second positioning antenna, a third positioning antenna, and a first computing device. The first positioning antenna, the second positioning antenna, and the third positioning antenna in the positioning system are attached to the first oscillating body. A first computing device in the positioning system obtains a first position, a second position, and a third position. Here, the first position, the second position, and the third position are positions measured by the first positioning antenna, the second positioning antenna, and the third positioning antenna, respectively.

The first computing device calculates the current attitude of the oscillating body at the first position from the first vector and the second vector. Here, the first vector is a vector from the first position to the second position. Moreover, the second vector is a vector from the first position to the third position. The first computing device modifies a first reference vector from the first positioning antenna to the first predetermined point in the attitude of the first oscillating body at the predetermined time, according to the calculated current attitude. Here, a given vector from the first positioning antenna to the first predetermined point in a predetermined attitude of the first oscillating body is defined as a first reference vector.

The modified first reference vector is a vector from the first position to the current first predetermined point (a vector to the first predetermined point with respect to the first position). Therefore, the first computing device calculates the position of the first predetermined point in the current posture of the first oscillating body by adding the first position to the modified first reference vector.

The first computing device also obtains a second predetermined point of a second oscillating body having a fourth positioning antenna, a fifth positioning antenna, and a sixth positioning antenna, the second predetermined point being in a current attitude of the second oscillating body. Here, the position of the second predetermined point is a position calculated based on a fourth position measured by a fourth positioning antenna, a fifth position measured by a fifth positioning antenna, and a sixth position measured by a sixth positioning antenna. Then, the first computing device refers to the position of the first predetermined point and the position of the second predetermined point, and calculates the current positional relationship between the first predetermined point and the second predetermined point.

As described above, the positioning system can calculate the position of a first predetermined point that is affected by the oscillation of the first oscillating body using the positions of three points on the first oscillating body measured by the three positioning antennas of the first oscillating body. Moreover, in the positioning system, the position of the second predetermined point of the second oscillating body calculated from the fourth position, the fifth position, and the sixth position is acquired. This makes it possible for the positioning system to grasp the positional relationship between the first predetermined point and the second predetermined point, which changes due to oscillation. As a result, it becomes possible to accurately grasp the positional relationship between the two oscillating bodies.

Hereinafter, specific embodiments of the present disclosure will be described with reference to the drawings. Unless otherwise specified, the hardware configuration, module configuration, functional configuration, and the like described in each embodiment are not intended to limit the technical scope of the disclosure to only those.

### FIRST EMBODIMENT

### System Overview

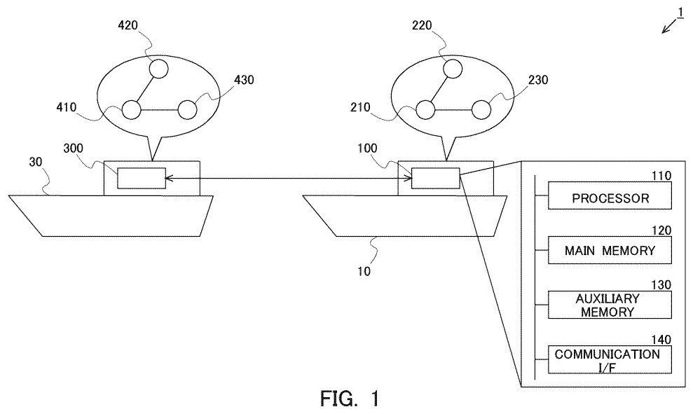

A positioning system 1 according to the present embodiment will be described with reference to FIG. 1. FIG. 1 is a diagram showing a schematic configuration of a positioning system 1. The positioning system 1 includes a first computing device 100, a first antenna 210, a second antenna 220, and a third antenna 230, as well as a second computing device 300, a fourth antenna 410, a fifth antenna 420, and a sixth antenna 430. In the positioning system 1, a first antenna 210, a second antenna 220, and a third antenna 230 are connected to a first computing device 100. In addition, in the positioning system 1, a fourth antenna 410, a fifth antenna 420, and a sixth antenna 430 are connected to the second computing device 300.

Moreover, the first computing device 100 and the second computing device 300 are configured to be able to communicate with each other. The first computing device 100 and the second computing device 300 communicate directly with each other via Wi-Fi (registered trademark), for example. As a result, even when the first computing device 100 and the second computing device 200 are located at sea and telephone communication networks such as mobile phones cannot be used, the first computing device 100 and the second computing device 300 can communicate with each other. In this case, the first computing device 100 and the second computing device 300 start communication when the first ship 10 (first computing device 100) and the second ship 30 (second computing device 300) are within communication range. The first computing device 100 and the second computing device 300 may communicate with each other via a WAN (Wide Area Network), which is a global public communication network such as the Internet, or a telephone communication network such as a mobile phone.

### (Antenna)

The first antenna 210, the second antenna 220, and the third antenna 230 are positioning antennas attached to the first ship 10. The first antenna 210, the second antenna 220, and the third antenna 230 are, for example, GNSS positioning antennas. The first antenna 210, the second antenna 220, and the third antenna 230 can measure the current positions of the first antenna 210, the second antenna 220, and the third antenna 230. The current positions measured by the first antenna 210, the second antenna 220, and the third antenna 230 are, for example, their respective latitude, longitude, and altitude.

The fourth antenna 410, the fifth antenna 420, and the sixth antenna 430 are positioning antennas attached to the second ship 30. The fourth antenna 410, the fifth antenna 420, and the sixth antenna 430 are also, for example, GNSS positioning antennas. The fourth antenna 410, the fifth antenna 420, and the sixth antenna 430 can measure the current positions of the fourth antenna 410, the fifth antenna 420, and the sixth antenna 430. The current positions measured by the fourth antenna 410, the fifth antenna 420, and the sixth antenna 430 are also, for example, latitude, longitude, and altitude, respectively.

In this embodiment, the first antenna 210, the second antenna 220, and the third antenna 230 are attached to the upper surface of the first ship 10. In addition, the fourth antenna 410, the fifth antenna 420, and the sixth antenna 430 are attached to the upper surface of the second ship 30. This makes it possible to prevent the first antenna 210, the second antenna 220, the third antenna 230, and the fourth antenna 410, the fifth antenna 420, and the sixth antenna 430 from being unable to receive radio waves from the GNSS satellites. It should be noted that the first antenna 210, the second antenna 220, and the third antenna 230 do not necessarily have to be mounted horizontally on the first ship 10. Furthermore, the fourth antenna 410, the fifth antenna 420, and the sixth antenna 430 do not necessarily have to be mounted horizontally on the second ship 30.

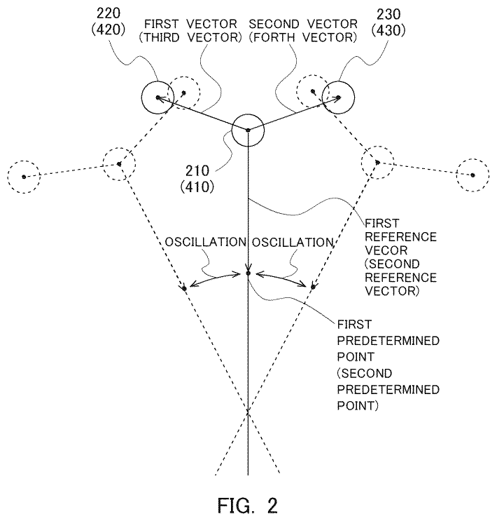

FIG. 2 is a diagram showing an example of changes in the positions of the antennas and the predetermined points when the first ship 10 and the second ship 30 are oscillating. FIG. 2 shows how the current position of the first antenna 210, the current position of the second antenna 220, and the current position of the third antenna 230 (hereinafter, these may be referred to as the “first position,” the “second position,” and the “third position,” respectively) change as the first ship 10 oscillates. In FIG. 2, the first antenna 210, the second antenna 220, the third antenna 230, the first vector (described later), the second vector (described later), and the first reference vector (described later) are drawn in solid lines when the first ship 10 is not oscillating. In addition, in FIG. 2, the first antenna 210, the second antenna 220, the third antenna 230, the first vector, the second vector, and the first reference vector when the first ship 10 is oscillating are drawn with dashed lines. As shown in FIG. 2, the first position, the second position, the third position, and the first predetermined point change as the first ship 10 oscillates.

As shown in FIG. 2, the current position (fourth position) of the fourth antenna 410, the current position (fifth position) of the fifth antenna 420, the current position (sixth position) of the sixth antenna 430, the third vector (described later), the fourth vector (described later), and the second reference vector (described later) also change as the second ship 30 oscillates.

### (Second Computing Device)

The second computing device 300 is a device that acquires the current positions of the fourth antenna 410, the fifth antenna 420, and the sixth antenna 430 in the second ship 30. The second computing device 300 acquires from the fourth antenna 410 the current position (fourth position) of the fourth antenna 410 measured by the fourth antenna 410. In addition, the second computing device 300 acquires the current position (fifth position) of the fifth antenna 420 measured by the fifth antenna 420 from the fifth antenna 420. In addition, the second computing device 300 acquires the current position (sixth position) of the sixth antenna 430 measured by the sixth antenna 430 from the sixth antenna 430. Then, the second computing device 300 communicates with the first computing device 100 to transmit the fourth position, the fifth position, and the sixth position to the first computing device 100.

### (First Computing Device)

The first computing device 100 is a device that calculates the position (latitude, longitude, and altitude) of a first predetermined point on the first ship 10. Here, the first predetermined point is an arbitrary point of the first ship 10. The first predetermined point is, for example, a point on the surface of the first ship 10. The first predetermined point may also be an internal point such as the center of gravity or center of buoyancy of the first ship 10, for example.

The first computing device 100 acquires from the first antenna 210 the current position (first position) of the first antenna 210 measured by the first antenna 210. In addition, the first computing device 100 acquires the current position (second position) of the second antenna 220 measured by the second antenna 220 from the second antenna 220. In addition, the first computing device 100 acquires the current position (third position) of the third antenna 230 measured by the third antenna 230 from the third antenna 230.

The first computing device 100 calculates a first vector and a second vector. Here, the first vector is a vector from the first position to the second position. Moreover, the second vector is a vector from the first position to the third position. Then, the first computing device 100 calculates the current attitude of the first ship 10 at the first position using the first vector and the second vector. Specifically, the first computing device 100 calculates the roll, pitch, and yaw of the first position.

Here, a first reference vector is predefined for a first predetermined point of the first ship 10. The first reference vector is a vector from the first antenna 210 to a first predetermined point at an attitude of the first ship 10 at predetermined time. Here, the attitude at a predetermined time is, for example, the attitude at a time when the first ship 10 is not oscillating. In other words, the attitude at a predetermined time is the attitude when the roll, pitch, and yaw in the first position are zero. The first computing device 100 modifies the first reference vector according to the current attitude of the ship 10 at the first position (the current attitude including the roll, pitch, and yaw at the first position). Then, the first computing device 100 calculates the position of the first predetermined point using the modified first predetermined point vector and the first position.

Furthermore, the first computing device 100 communicates with the second computing device 300 to receive the fourth position, the fifth position, and the sixth position from the second computing device 300. The first computing device 100 calculates the position of the second predetermined point on the second ship 30 from the fourth position, the fifth position, and the sixth position in the same manner as it calculates the position of the first predetermined point from the first position, the second position, and the third position. Here, the second predetermined point is an arbitrary point of the second ship 30. The second predetermined point is, for example, a point on the surface of the second ship 30. The second predetermined point may also be an internal point such as the center of gravity or center of buoyancy of the second ship 30, for example.

Specifically, the first computing device 100 calculates a third vector and a fourth vector, and calculates the current attitude of the second ship 30 at the fourth position. Here, the third vector is a vector from the fourth position to the fifth position. Moreover, the fourth vector is a vector from the fourth position to the sixth position. Further, a second reference vector is predetermined for the second predetermined point of the second ship 30. The second reference vector is a vector from the fourth antenna 410 to a second predetermined point at an attitude of the second ship 30 at a predetermined time. Here, the posture at a predetermined time is, for example, the posture at a time when the second ship 30 is not oscillating. The first computing device 100 corrects the second reference vector in accordance with the current attitude of the second ship 30 at the fourth position, and calculates the position of the second predetermined point. The method by which the first computing device 100 corrects the first reference vector (second reference vector) and the method by which the first computing device 100 calculates the position of the first predetermined point (second predetermined point) will be described in detail later.

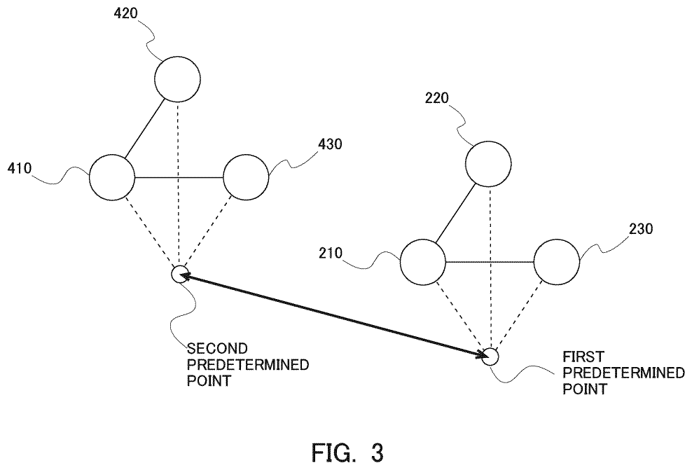

FIG. 3 is a diagram showing the positional relationship between a first predetermined point of the first ship 10 and a second predetermined point of the second ship 30. FIG. 3 shows the position of a first predetermined point calculated from the first position, second position, and third position acquired by the first antenna 210, the second antenna 220, and the third antenna 230, and the position of a second predetermined point calculated from the fourth position, fifth position, and sixth position acquired by the fourth antenna 410, the fifth antenna 420, and the sixth antenna 430. The first computing device 100 calculates the positional relationship between the first predetermined point and the second predetermined point from the calculated positions of the first predetermined point and the second predetermined point.

Here, the positional relationship between the first predetermined point and the second predetermined point includes, for example, the distance between the first predetermined point and the second predetermined point and the direction with the first predetermined point as the base point. Furthermore, the positional relationship between the first predetermined point and the second predetermined point may be a relative distance to the second predetermined point with the first predetermined point as a reference. Furthermore, the positional relationship between the first predetermined point and the second predetermined point may include a relative speed between the first predetermined point and the second predetermined point using the first predetermined point as a reference. In this case, the first computing device 100 calculates the relative speed between the first predetermined point and the second predetermined point by calculating the time transition of the relative distance between the first predetermined point and the second predetermined point. The positional relationship between the first predetermined point and the second predetermined point may include a relative distance, a direction, and a relative speed based on the second predetermined point.

The first computing device 100 includes a computer having a processor 110, a main memory 120, an auxiliary memory 130, and a communication interface (communication I/F) 140. The processor 110 is, for example, a central processing unit (CPU) or a digital signal processor (DSP). The main memory 120 is, for example, a RAM (Random Access Memory). The auxiliary memory 130 is, for example, a ROM (Read Only Memory). The auxiliary memory 130 is, for example, a HDD (Hard Disk Drive), or a disk recording medium such as a CD-ROM, a DVD disk, or a Blu-ray disk. The auxiliary memory 130 may be a removable medium. Here, examples of removable media include a USB memory and an SD card.

In the first computing device 100, the auxiliary memory 130 stores an operating system (OS), various programs, various information tables, and the like. Furthermore, in the first computing device 100, the processor 110 can realize various functions, which will be described later, by loading a program stored in the auxiliary memory 130 into the main memory 120 and executing it. However, some or all of the functions of the first computing device 100 may be realized by a hardware circuit such as an ASIC or an FPGA. The first computing device 100 does not necessarily have to be realized by a single physical configuration, and may be configured by a plurality of computers that work in cooperation with each other. Similarly to the first computing device 100, the second computing device 300 also includes a computer.

### (Functional Configuration)

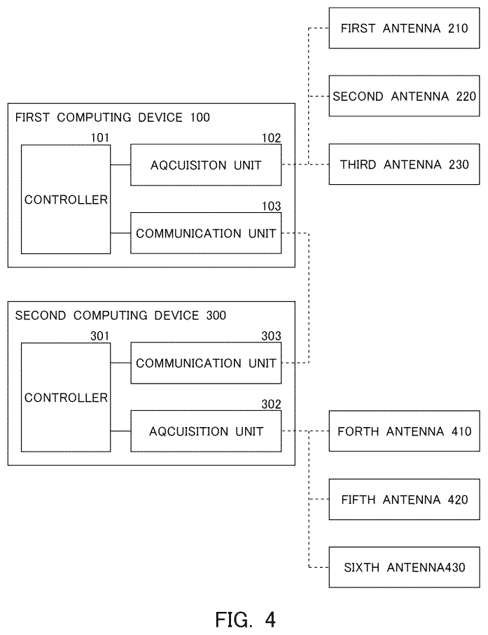

Next, the functional configuration of the first computing device 100 and the second computing device 300 that configure the positioning system 1 will be described with reference to FIG. 4. FIG. 4 is a block diagram illustrating an example of a functional configuration of the first computing device 100 and the second computing device 300 that configure the positioning system 1.

### (Second Computing Device)

The second computing device 300 includes a control unit 301, an acquisition unit 302, and a communication unit 303. The control unit 301 has a function of performing arithmetic processing for controlling the second computing device 300. The control unit 301 can be realized by a processor in the second computing device 300. The acquisition unit 302 has a function of acquiring the current positions from the fourth antenna 410, the fifth antenna 420, and the sixth antenna 430. The acquisition unit 302 can be realized by an interface for connecting the second computing device 300 to each antenna. The communication unit 303 has a function of communicating with the first computing device 100. The communication unit 303 can be realized by a communication I/F in the second computing device 300.

The control unit 301 acquires the current positions (fourth position, fifth position, and sixth position) of the fourth antenna 410, the fifth antenna 420, and the sixth antenna 430, respectively, by the acquisition unit 302. Then, the control unit 301 transmits the fourth position, the fifth position, and the sixth position to the first computing device 100 via the communication unit 303.

### (First Computing Device)

The first computing device 100 includes a control unit 101, an acquisition unit 102, and a communication unit 103. The control unit 101 has a function of performing arithmetic processing for controlling the first computing device 100. The control unit 101 can be realized by the processor 110 in the first computing device 100. The acquisition unit 102 has a function of acquiring the current positions from the first antenna 210, the second antenna 220, and the third antenna 230. The acquisition unit 102 can be realized by an interface for connecting the first computing device 100 and each antenna. The communication unit 103 has a function of communicating with the second computing device 300. The communication unit 103 can be realized by the communication I/F 140 in the first computing device 100.

The control unit 101 acquires the current positions (first position, second position, and third position) of the first antenna 210, the second antenna 220, and the third antenna 230, respectively, by the acquisition unit 102. The control unit 101 calculates a first vector using the first position and the second position. Furthermore, the control unit 101 calculates a second vector using the first position and the third position. In this embodiment, each component of the first vector and the second vector is set using a coordinate system of latitude, longitude, and altitude.

The control unit 101 calculates the current attitude of the first ship 10 at the first position by calculating the roll, pitch, and yaw at the first position using the first vector and the second vector. Here, in this embodiment, the roll, pitch, and yaw of the first position are determined by angles around the latitudinal axis, the longitudinal axis, and the altitude axis with the first position as the reference (origin) using latitude, longitude, and altitude as a coordinate system. Then, the control unit 101 corrects the first reference vector in accordance with the calculated current attitude of the first ship 10 at the first position.

Now, assume that the current attitude of the first ship 10 at the first position is represented by a roll with a roll angle r, a pitch with a pitch angle p, and a yaw with a yaw angle h. The corrected first reference vector (x′, y′, z′) is expressed by the following equation using the rotation matrices for the roll angle r, pitch angle p, and yaw angle h, and the first reference vector before correction (x, y, z). Here, the first reference vector is defined by a coordinate system defined by latitude, longitude, and altitude.

$$( \begin{matrix}{x}^{′} \\ {y}^{′} \\ {z}^{′}\end{matrix} ) = ( \begin{matrix}1 & 0 & 0 \\ 0 & cos r & - sin r \\ 0 & sin r & cos r\end{matrix} ) ( \begin{matrix}cos p & 0 & - sin p \\ 0 & 1 & 0 \\ sin p & 0 & cos p\end{matrix} ) ( \begin{matrix}cos h & - sin h & 0 \\ sin h & cos h & 0 \\ 0 & 0 & 1\end{matrix} ) ( \begin{matrix}x \\ y \\ z\end{matrix} )$$

The corrected first reference vector (x′, y′, z′) is a vector from the first position to the current first predetermined point using the latitude, longitude, and altitude as a coordinate system. Therefore, the control unit 101 calculates the current position of the first predetermined point by adding each component of the coordinates of the first position to each component of the corrected first predetermined point vector (x′, y′, z′).

The control unit 101 receives the fourth position, the fifth position, and the sixth position from the second computing device 300 via the communication unit 103. The control unit 101 calculates a third vector using the fourth position and the fifth position. Furthermore, the control unit 101 calculates a fourth vector using the fourth position and the sixth position.

Then, the control unit 101 calculates the current attitude of the second ship 30 at the fourth position using the third vector and the fourth vector. Then, the control unit 101 corrects the second reference vector in accordance with the current attitude of the second ship 30 at the calculated fourth position. Then, the control unit 101 calculates the current position of the second predetermined point by adding each component of the coordinates of the fourth position to each component of the corrected second predetermined point. Here, the second reference vector, which is a vector from the fourth antenna 410 to the second predetermined point in the attitude of the second ship 30 at a predetermined time, is grasped by the control unit 101 as a given vector. Furthermore, the control unit 101 may receive a second reference vector from the second computing device 300 when receiving the fourth position, the fifth position, and the sixth position. The method for calculating the current position of the second predetermined point using the fourth position, the fifth position, and the sixth position is similar to the method for calculating the current position of the first predetermined point using the first position, the second position, and the third position (described above), so a description thereof will be omitted.

### (Flowchart)

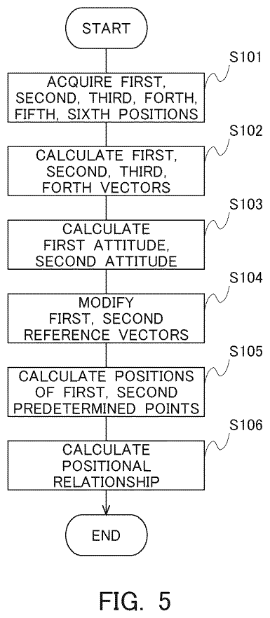

Next, information processing executed by the control unit 101 in the first computing device 100 in the positioning system 1 will be described with reference to FIG. 5. FIG. 5 is a flowchart of information processing executed by the control unit 101 in the first computing device 100. The information processing shown in FIG. 5 is processing for calculating the positional relationship between the first ship 10 and the second ship 30. The information processing shown in FIG. 5 is repeatedly executed at predetermined intervals when the first computing device 100 and the second computing device 300 start communication.

In the information processing shown in FIG. 5, first, in S101, the first position, the second position, and the third position are acquired from the first antenna 210, the second antenna 220, and the third antenna 230. In addition, in S101, the fourth position, the fifth position, and the sixth position are acquired by receiving them from the second computing device 300. Next, in S102, a first vector and a second vector are calculated using the first position, the second position, and the third position. In addition, in S102, a third vector and a fourth vector are calculated using the fourth position, the fifth position, and the sixth position.

Next, in S103, the attitude of the first ship 10 at the first position (first attitude) is calculated using the first vector and the second vector. In addition, in S103, the attitude of the second ship 30 at the fourth position (second attitude) is calculated using the third vector and the fourth vector. Next, in S104, the first reference vector is corrected using the attitude of the first ship 10 at the first position. In addition, in S104, the second reference vector is corrected using the attitude of the second ship 30 at the fourth position.

Next, in S105, the position of the first predetermined point is calculated using the corrected first vector and the first position. In addition, in S105, the position of the second predetermined point is calculated using the predetermined pointed second vector and the fourth position. Next, in S106, the positional relationship between the first predetermined point and the second predetermined point is calculated using the positions of the first predetermined point and the second predetermined point calculated in S105.

As described above, in the positioning system 1, the positional relationship between the first predetermined point and the second predetermined point is calculated from the current positions of the antennas. This makes it possible to grasp the positional relationship between the first predetermined point and the second predetermined point that are affected by the oscillation of the first ship 10 and the second ship 30. As a result, it is possible to accurately grasp the positional relationship between the first ship 10 and the second ship 30. Furthermore, if the first predetermined point is a point on the surface of the first ship 10 and the second predetermined point is a point on the surface of the second ship 30, it is possible to calculate the distance between the surface of the first ship 10 and the surface of the second ship 30. This makes it possible to ensure safety when, for example, the first ship 10 is attempting to come alongside the second ship 30.

### (Variation 1)

In this embodiment, the coordinate system used for the (first and second) reference vectors is a latitude, longitude and altitude coordinate system. However, the coordinate system used for the reference vectors may be other than that defined by latitude, longitude, and altitude. For example, it may be a coordinate system in the direction of travel of the first ship 10 (second ship 30), the lateral direction of the first ship 10 (second ship 30), and the upward direction of the first ship 10 (second ship 30). In addition, the coordinate system used for the attitude, etc. of the first ship 10 (second ship 30) may be a coordinate system different from the coordinate system determined by latitude, longitude, and altitude. In this case, the first computing device 100 calculates the positions of the (first and second) predetermined points by appropriately performing coordinate conversion.

### (Variation 2)

In this embodiment, the position of a predetermined point of the ship is calculated. That is, in the present embodiment, the position of a predetermined point of the moving body among the floating bodies is calculated. However, this embodiment can also be applied to floating bodies that do not move, such as offshore wind power generation facilities. Furthermore, the floating body (moving body) may be an object that floats in the air, such as an airplane or a drone. Furthermore, the vehicle oscillates due to vibrations while traveling or acceleration (forward/rearward or lateral acceleration) that occurs while traveling. Furthermore, buildings also oscillate due to the effects of earthquakes or wind. Therefore, this embodiment can also be applied to objects other than floating bodies such as vehicles or buildings.

### (Variation 3)

In this embodiment, the first computing device 100 is directly connected to the first antenna 210, the second antenna 220, and the third antenna 230. In addition, the second computing device 300 is directly connected to the fourth antenna 410, the fifth antenna 420, and the sixth antenna 430. However, the connection with the antenna need not be limited to this example. In another example, the first computing device 100 (second computing device 300) may be indirectly connected to at least one of the first antenna 210, the second antenna 220, and the third antenna 230 (the fourth antenna 410, the fifth antenna 420, and the sixth antenna 430) via one or more external computers such as relay devices.

### (Variation 4)

In addition, the first computing device 100 may obtain the attitude of the first ship 10 using an inertial measurement unit when the current position of at least one of the first antenna 210, the second antenna 220, and the third antenna 230 cannot be obtained. Here, the inertial measurement unit is mounted on the first ship 10. Then, the first computing device 100 acquires the current position of the antenna whose current position can be acquired among the first antenna 210, the second antenna 220, or the third antenna 230, and modifies the first reference vector from the antenna to the first predetermined point according to the current attitude of the first ship 10 at the current position of the antenna. The first computing device 100 may obtain the current position of the inertial measurement unit and correct the reference vector from the inertial measurement unit to a predetermined point. In this way, even if all three antennas on the first ship 10 are unable to acquire their current positions, the accurate position of the first predetermined point can be determined.

In addition, the second computing device 300 may also obtain the attitude of the second ship 30 using an inertial measurement unit when the current position of at least one of the fourth antenna 410, the fifth antenna 420, and the sixth antenna 430 cannot be obtained. Then, the second computing device 300 acquires the current position of the antenna from among the fourth antenna 410, the fifth antenna 420, or the sixth antenna 430 for which the current position has been acquired, and transmits it to the first computing device 100 together with the attitude of the second ship 30. In this way, even if all three antennas on the second ship 30 are unable to acquire the current position, the accurate position of the second predetermined point can be determined.

### (Variation 5)

In this embodiment, the first computing device 100 calculates the position of the second predetermined point using the fourth position, the fifth position, and the sixth position. As a result, even if the second computing device 300 does not have the function to calculate the position of the second predetermined point, the first computing device 100 can calculate the position of the second predetermined point and calculate the positional relationship between the first predetermined point and the second predetermined point. On the other hand, in this modified example, the second computing device 300 calculates the position of the second predetermined point using the fourth position, the fifth position, and the sixth position. In this case, the second computing device 300 calculates the position of the second predetermined point using the fourth position, the fifth position, and the sixth position, and then transmits the calculated position to the first computing device 100 by communication. The first computing device 100, which has received the position of the second predetermined point, calculates the positional relationship between the first predetermined point and the second predetermined pointed using the calculated position of the first predetermined point and the received position of the second predetermined point. In this way, the first computing device 100 and the second computing device 300 each calculate the position of the predetermined point, so that the load on the first computing device 100 for calculating the position of the predetermined point can be reduced. Therefore, it is possible to accurately grasp the positional relationship between the first ship 10 and the second ship 30 while shortening the time required to calculate the position of a predetermined point.

### OTHER EMBODIMENTS

The above-described embodiment is merely an example, and the present disclosure can be modified as appropriate without departing from the spirit and scope of the present disclosure. Furthermore, the processes and means described in this disclosure can be freely combined and implemented as long as no technical contradiction occurs.

Furthermore, the processes described as being performed by one device may be shared and executed by a plurality of devices. Alternatively, the processes described as being performed by different devices may be performed by a single device. In a computer system, the hardware configuration (server configuration) by which each function is realized can be flexibly changed.

The present disclosure can also be realized by supplying a computer program implementing the functions described in the above embodiments to a computer, and having one or more processors of the computer read and execute the program. Such a computer program may be provided to the computer by a non-transitory computer-readable storage medium connectable to the system bus of the computer, or may be provided to the computer via a network. A non-transitory computer-readable storage medium includes any type of medium suitable for storing electronic instructions, such as, for example, any type of disk, such as a magnetic disk (such as a floppy disk or a hard disk drive (HDD)), an optical disk (such as a CD-ROM, a DVD disk, or a Blu-ray disk), a read-only memory (ROM), a random-access memory (RAM), an EPROM, an EEPROM, a magnetic card, a flash memory, or an optical card.

What is claimed is:

1. A positioning system including a first positioning antenna, a second positioning antenna, and a third positioning antenna attached to a first oscillating body, and a first computing device,
the first computing device configured to execute;
acquiring a first position measured by the first positioning antenna, a second position measured by the second positioning antenna, and a third position measured by the third positioning antenna,
calculating a current attitude of the first oscillating body at the first position from a first vector from the first position to the second position and a second vector from the first position to the third position,
modifying a first reference vector from the first positioning antenna to a first predetermined point in the attitude of the first oscillating body at a predetermined time according to the calculated current attitude of the first oscillating body at the first position,
calculating a position of the first predetermined point in the current attitude of the first oscillating body by adding the modified first reference vector to the first position,
acquiring a second predetermined point of a second oscillating body to which a fourth positioning antenna, a fifth positioning antenna, and a sixth positioning antenna are attached, the second predetermined point being calculated based on a fourth position measured by the fourth positioning antenna, a fifth position measured by the fifth positioning antenna, and a sixth position measured by the sixth positioning antenna in a current attitude of the second oscillating body, and
calculating a current positional relationship between the first predetermined point and the second predetermined point by referring to a position of the first predetermined point and a position of the second predetermined point.

2. The positioning system according to claim 1, wherein
acquiring the position of the second predetermined point includes,
acquiring the fourth position, the fifth position, and the sixth position,
calculating a current attitude of the second oscillating body at the fourth position from a third vector from the fourth position to the fifth position and a fourth vector from the fourth position to the sixth position,
modifying a second reference vector from the fourth positioning antenna to the second predetermined point in the attitude of the second oscillating body at a predetermined time in accordance with the calculated current attitude of the second oscillating body at the fourth position, and
calculating the position of the second predetermined point in the current attitude of the second oscillating body by adding the modified second reference vector to the fourth position.

3. The positioning system according to claim 1, wherein
the first computing device is capable of communicating with a second computing device attached to the second oscillating body, and
the second computing device is configured to execute;
acquiring the fourth position, the fifth position, and the sixth position,
calculating a current attitude of the second oscillating body at the fourth position from a third vector from the fourth position to the fifth position and a fourth vector from the fourth position to the sixth position,
modifying a second reference vector from the fourth positioning antenna to the second predetermined point in the attitude of the second oscillating body at a predetermined time in accordance with the calculated current attitude of the second oscillating body at the fourth position, and
calculating a position of the second predetermined point in the current attitude of the second oscillating body by adding the modified second reference vector to the fourth position, and
acquiring the position of the second predetermined point includes receiving, by the first computing device, the position of the second predetermined point calculated by the second computing device from the second computing device.

4. A non-transitory storage medium storing a positioning program for causing a computing device connected to a first positioning antenna, a second positioning antenna, and a third positioning antenna attached to a first oscillating body to execute an information processing method, wherein
the information processing method includes,
acquiring a first position measured by the first positioning antenna, a second position measured by the second positioning antenna, and a third position measured by the third positioning antenna,
calculating a current attitude of the first oscillating body at the first position from a first vector from the first position to the second position and a second vector from the first position to the third position,
modifying a first reference vector from the first positioning antenna to a first predetermined point in the attitude of the first oscillating body at a predetermined time according to the calculated current attitude of the first oscillating body at the first position,
calculating a position of the first predetermined point in the current attitude of the first oscillating body by adding the modified first reference vector to the first position,
acquiring a second predetermined point of a second oscillating body to which a fourth positioning antenna, a fifth positioning antenna, and a sixth positioning antenna are attached, the second predetermined point being calculated based on a fourth position measured by the fourth positioning antenna, a fifth position measured by the fifth positioning antenna, and a sixth position measured by the sixth positioning antenna in a current attitude of the second oscillating body, and
calculating a current positional relationship between the first predetermined point and the second predetermined point by referring to a position of the first predetermined point and a position of the second predetermined point.

5. The non-transitory storage medium according to claim 4, wherein
acquiring the position of the second predetermined point includes,
acquiring the fourth position, the fifth position, and the sixth position,
calculating a current attitude of the second oscillating body at the fourth position from a third vector from the fourth position to the fifth position and a fourth vector from the fourth position to the sixth position,
modifying a second reference vector from the fourth positioning antenna to the second predetermined point in the attitude of the second oscillating body at a predetermined time in accordance with the calculated current attitude of the second oscillating body at the fourth position, and
calculating the position of the second predetermined point in the current attitude of the second oscillating body by adding the modified second reference vector to the fourth position.
